(19) United States
(12) Patent Application Publication
(10) Pub. No.: US 2003/0126070 A1
(43) Pub. Date: Jul. 3, 2003

(54) Interim loan guarantee method

(76) Inventor: Fred Louis Jarm, Woodridge, IL (US)

Correspondence Address: FRED L. JARM, JR., 7961 BURR RIDGE CT # 212, WOODRIDGE, IL, 60517, US

(21) Appl. No.: 10/034,461

(22) Filed: Dec. 28, 2001

(51) Int. Cl. G06F 17/60

(52) U.S. Cl. 705/38

(57) ABSTRACT

A business method is disclosed which provides a useful, concrete and tangible result of enabling an automobile dealer or other business selling property purchased by consumers utilizing financing with a retail installment contract. The method provides the ability of having immediate monies and protection from any or several risks of not receiving monies as a result of the assignment or sale of retail installment sales contracts or other instruments of finance, such as, but not limited to, leases, portfolios of several contracts, or invoices for cash being rejected and returned “unpaid”.

1. Retail “credit impaired” consumer (customer) comes to auto dealer in response to dealer's advertising welcoming people with credit problems.

2. Dealer submits credit application to various sub-prime sales finance agencies (Lenders).

3. Lender obtains credit bureau report and reviews application.

4. Provided credit bureau and information on the application meets with lender's policies and guidelines, dealer is sent a conditional approval. (Final funding is contingent on verification of information on application after contract package is received by lender.)

5. Dealer obtains copies of required documentation. These documents are customarily the following:

a. Copy of recent pay stub

b. Copy of telephone bill

c. Copy of drivers license

d. Rent or mortgage receipt

e. 6 or 8 references

f. Insurance information

g. Bankruptcy Discharge Letter—if applicable

Dealer then collects the down payment and has the required paperwork signed.

This paper work usually consist of the following:

h. Retail Installment Contract

i. Title application

j. Bill of Sale

k. Odometer Statement (s)

l. Agreement To Provide Insurance

m. Tax Forms

n. Other miscellaneous documents

The vehicle is then delivered to the consumer.

6. Dealer now prepares the contract package, which consists of the original Retail Installment Contract, Credit Application, and copies of all other items referred to in #5 above, and then forwards (sends) to the lender.

7. Upon receipt of the package, lender begins verifications with at least: a) the consumer's employer b) insurance agent, and c) landlord. This verification process may take several days and many times situations occur which require new or additional documents and explanations. Thus, resulting in delays and communications from lender to dealer, dealer to consumer, consumer to lender, and dealer, etc.

8. Provided all verifications are eventually completed to lenders satisfaction, a check or ACH electronic funding is made by the lender to dealer.

This process is significantly different from what dealers are accustomed to with their conventional lenders. The conventional lenders (GMAC, Ford Credit, dealer's, bank, etc.) require only the contract, credit application, and insurance information. Furthermore, their approvals are not subject to later verifications and the dealer is funded immediately.

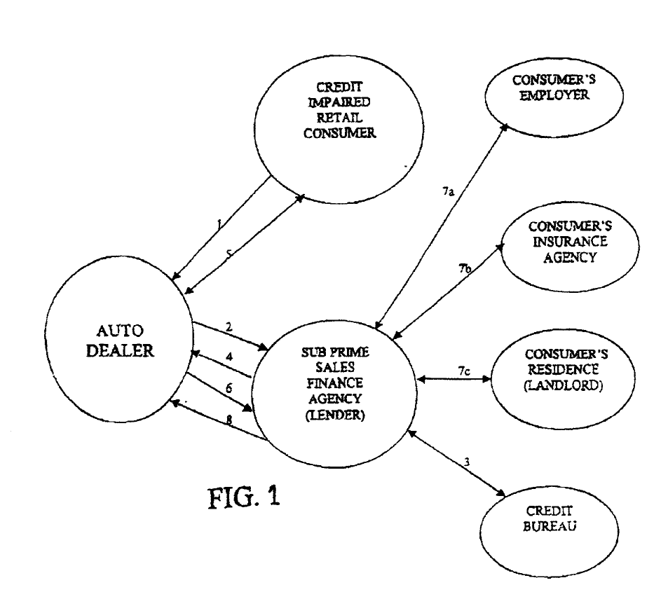

The process described above and in FIG. 1 results in two important concerns facing the auto dealer:

1. An average of 2 weeks delay in funding (from delivery data until funding).

2. The possibility of the contact being returned, unfunded, to the dealer by the lender for any of several reasons-such as, but not limited to:

a. Customer changes employment

b. Vehicle is confiscated

c. Customer leaves town (skip)

d. Lender ceases operations

e. Misrepresentation by customer

When the dealer contracts with Interim Funding. L.L.C. (exhibit A), these two major inefficiencies of the industry are addressed..

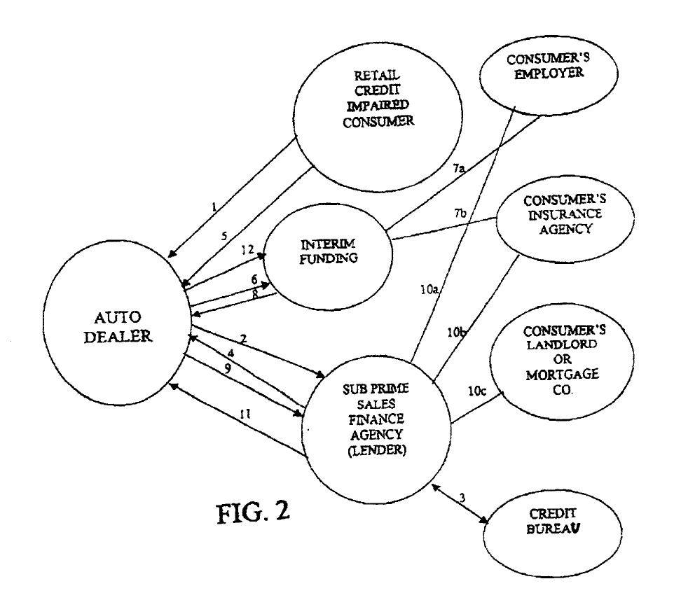

The comparison of FIGS. 1 and 2 will indicate that steps 1 through 5 are identical and re-stated here. The change and improvements are reflected in steps 6.7, and 8, whereby the dealer obtains a Guarantee Authorization Number, which enables the dealer to complete and deposit one of Interim Funding's checks and be guaranteed that should the contract be rejected by the approving lender, the dealer will be able to find a new lender with Interim Funding's enhancements less a $500“additional claim discount”.

When the dealer is funded by the lender, Interim Funding electronically deducts (via ACH) the proceeds from the dealer's checking account.

1. Retail “Credit Impaired” Consumer (customer) comes to Auto Dealer in response to dealer's advertising welcoming people with credit problems.

2. Dealer submits credit application to various sub-prime sales finance agencies (Lender).

3. Lender obtains credit bureau report and reviews application.

4. Provided credit bureau information on application meets with lenders policies and guidelines, dealer is sent a conditional approval. ( Final funding is contingent on verification of information on application after contract package is received by Lender.)

5. Dealer obtains copies of required documentation. These documents are customarily the following:

a) Copy of Recent Pay Stub.

b) Copy of Telephone bill.

c) Copy of Drivers License.

d) Rent or Mortgage Receipt.

e) 6 or 8 References.

f) Insurance information.

g) Bankruptcy discharge letter if applicable.

Dealer then collects the down payment and has the required paperwork signed. This paperwork usually consists of the following:

h) Retail Installment Contract

i) Title Application

j) Bill of Sale

k) Odometer Statement(s)

l) Agreement to Provide Insurance

m) Tax Form

n) Other miscellaneous documents

The vehicle is then delivered to the consumer.

6. Dealer prepares the Interim Funding Approval Guarantee/Funding Request (exhibit B) and transmits via fax to Interim along with copies of:

a) consumer's pay stub

b) insurance information

c) lender's approval

d) bill of sale

Dealer determines if he desires the guarantee only or guarantee and immediate funding.

7. Interim then reviews the documents-primarily the pay stub to determine its authenticity and accuracy. We look for garnishments and apply the 7.65% factor to gross income compared to the total of FICA and Medicare-calculations are done to determine if the income received according to the stub reflects what is stated on the application. IN 7a and 7b, Interim verifies employment and insurance.

8. Provided the car is insured, the consumer is employed and other aspects of the transaction reflect a great likelihood of the deal meeting the lender's standard and being funded. Interim transmits to the dealer the guarantee/funding authorization number (exhibit C).

The dealer then prepares the Interim Funding check (exhibit D), the promissory note (exhibit E) and the assignment of proceeds (exhibit F). Then the dealer deposits the Interim check in his bank and sends the note and assignment of proceeds to Interim.

9. Dealer now prepares the contract package, which consists of the original Retail Installment Contract, Credit Application (s), and copied of all other items referred to in #5 above, and then forwards (sends) to the lender.

10. Upon receipt of the package, lender begins verifications with at least: a) the consumer's employer, b) insurance agent, c) landlord. This verification process may take several days and many times situations occur which require new or additional documents and explanations, resulting in delays and communications from lender to dealer, dealer to consumer, consumer to lender and dealer, etc.

11. Provided all verifications are eventually completed to leaders satisfaction, a check or ACH electronic funding is made by the lender to dealer.

12. Interim has been monitoring the process every 3 days after authorization is given as follows:

a) First 3 days—verify loan package received at lender

b) Second 3 days—determine if any problem exists

c) Third 3 days—determine if deal is funded

d) Fourth 3 days—96% of the business is funded by this time. Dealer is notified and an ACH is initiated (exhibit G).

In summary and conclusion; the Interim Funding, L.L.C. method of doing business is unique and original in that it:

1. Eliminates the average two week delay in being funded or paid for assigned retail installment contracts, and

2. eliminates the possibility of contracts begin returned as “unfundable” for a variety of reasons other than dealer fraud or misrepresentations.

As a dealer who wants to remain competitive, you're interested in special financing.

You know that special financing enables you to sell to more consumers. And you know these deals are more lucrative than the majority of your deals. But you may have reservations about special financing despite the benefits it offers.

Perhaps you've heard that dealers are often exposed to risk for over two weeks while waiting for their money.

Maybe a dealer you know had contracts out to a lender who then experienced financial distress.

Or you may know a dealer who delivered a car that was totaled, stolen or confiscated before the lender funded the deal.

These are risks that must be considered. In fact, these issues are exactly why Interim Funding was established. We believe that special financing should be as safe and easy as conventional financing. You'll be pleased to find that our program addresses all of your concerns.

When you accept credit cards or use a check guarantee service, you routinely pay 2%-3% to get your funds in the bank as soon as possible. After all, money in your bank account is more useful than money owed to you. In a special financing deal, however, money in your bank account is a requirement. Your floor plan lender expects prompt payment when you sell a car. But it can be weeks before your approving lender is able to pay you. That leaves you in a difficult situation.

Some dealerships take units to the auction in order to get cash quickly. Although it can ease the cash crunch, paying to get the car to the auction and then paying the sales fee, only to sell your car at a wholesale price, leaves something to be desired. On top of that, you're depleting your inventory, making it more difficult to sell the next car. The auction's sale fee alone is usually more than $150, about the same as Interim Funding's fee on a $10,000 contract.

In delivering cars to sub-prime borrowers (usually with sub-standard insurance-if any) you're at risk if something happens to the car before you receive payment from the approving lender.

When you sell to a customer with sub-prime credit, use one of our signed blank checks and you'll have your money right away—before the approving lender receives the loan package! Or, if you prefer, we can electronically fund your account (ACH).

We protect you from almost all insurable risks. You'll have fire, theft, collision, confiscation, and skip coverage. This protection covers the contract amount—not just the ACV of the vehicle—so you won't have to worry about getting stuck with an $8000 insurance check for an $11,000 contract. All of this protection is included in our low discount and processing fees.

You are also protected in another, more subtle way. Several sub-prime lenders have experienced financial distress over the past six years. Although you will continue to use your same trusted lenders, the fact that Interim Funding pays you immediately virtually eliminates your exposure to this potential risk.

Interim Funding's program doesn't interfere in any way with your lender relationship.

The contract is assigned by you directly to the lender.

We provide assistance and monitoring of your department and can help you get started in special financing if you've been putting it off because of the risks.

The world of special finance has its characters. You've seen them. You have special names for them. Some are just down on their luck, caught by unforeseen circumstances. Others haven't a clue and never will. Problem is, you need to sell more units but don't want to get burned.

Each one of these cases represents a risk that looms overhead. You could be exposed for over two weeks while waiting for your money. The lender you thought was solid starts to experience financial distress. Or your customer has the car you sold him totaled, stolen or confiscated before the lender funded the deal.

These issues are the reason behind Interim Funding's existence. We feel that you should be able to take advantage ofthe benefits special funding has to offer without the risk. It is our goal that special financing be as safe and easy as conventional financing.

What if we told you we could guarantee your contracts? We can. And we can do it affordably and with a minimum of hassle. Our Approval Guarantee Program features prescreening, insurance, deal monitoring, and most important, a guarantee for as little as $39.

Your guarantee provides coverage for “bounced” or returned deals due to;

job gap;

skip, confiscation or collateral jeopardy;

lender financial distress;

customer misrepresentations;

over advance or term; or

additional, unobtainable stips.

We can even give you a way to go if your customer loses his job.

We can provide this guarantee with confidence because our initial screening process is designed to catch a problem before it hits the lender. Our analysis of the deal structure assures less than 5% of the contracts will be problems.

Aside from having a great price, the Approval Guarantee Program couldn't be easier to use . . .

Work the deal as usual.

Obtain written approval(s) from your usual sources,

Select lender which provides the best profit and contract deal.

Prepare IFC approval guarantee request.

Fax guarantee request together with recent pay stub, credit application, approval letter, proof of insurance and buyers order.

Within twenty minutes (during regular business hours) you will receive confirmation and approval guarantee number.

Send loan package to approving lender as usual. IFC verifies complete loan package receipt at lender.

Work with lFC, lender, and your customer to assist in providing any missing stips verifications lender may require.

As you can see the process is fairly painless. It is also important to us that the program is flexible. You retain the option to unwind the deal rather than assume any additional discount or liability. You can also reassign the contract to another lender with IFC's guarantee. If arrangement is not made with a lender to accept the contract within 21 days we will take the assignment. We can even assist you in collection of the first payment.

Interim Funding, L.L.C. is a unique, specialty lending company providing money and protection to automobile dealers involved in Special Finance (Sub-Prime lending) for their “credit impaired” customers.

We do not make loans to customers or purchase and/or service installment contracts. We do, however, advance 99% of the expected proceeds from the assignment of any contract to a special finance sales financing agency and, in addition, we guarantee that the contract will be purchased should the anticipated dealer arranged assignment not be accepted.

Our bookthedeal.com enables a dealer to guarantee and/or fund a deal through e-business 24 hours a day, 7 days a week.

Many dealers have been surprised by the difference in funding time between conventional and sub-prime lenders. In addition, several situations can (and do) occur from the time of delivery up until the time of funding which is an average of 2 weeks. This is why Interim Funding was created; immediate funding and protection against deals unwinding.

Bookthedeal.com, the e-business site of Interim Funding, L.L.C., is a unique, specialty lending company providing money and protection to automobile dealers involved in Special Finance (Sub-Prime lending) for their “credit impaired” customers.

We do not make loans to customers or purchase and/or service installment contracts. We do, however, advance 99% of the expected proceeds from the assignment of any contract to a special finance sales financing agency and, in addition, we guarantee that the contract will be purchased should the anticipated dealer arranged assignment not be accepted.

Bookthedeal.com enables a dealer to guarantee and/or fund a deal through e-business 24 hours a day, 7 days a week.

Many dealers have been surprised by the difference in funding time between conventional and sub-prime lenders. In addition, several situations can (and do) occur from the time of delivery up until the time of funding which is an average of 2 weeks. This is why Interim Funding was created; immediate funding and protection against deals unwinding.

Solution for Monday Morning Madness

By: Greg Goebel

With over ten years experience in, all types of Special Finance, I have participated in more than a few 20 Group discussions concerning Monday Morning Madness. You know it-that big direct mail sale has made your month in a weekend. The sales staff is pumped, the sales manager's head will barely fit through the door, and the finance desk is absolutely buried!

About that time the office manager reminds the dealer while he is looking over the DOC that they now have (fill in the dollars for the size of your dealership) one third of the normal MONTHLY floor plan payoffs due 72 hours from now. The dealer then picks up the phone and dials the finance office to check the status of the contracts-intransit. In that discussion it is learned that half of the deals are spotted, the rest are with assorted lenders that fund over a period of weeks rather than days, and, oh by the way, ABC lender is sending back four other deals from a week ago because the telephone's have been disconnected. The dealer is wondering why on earth he ever allowed himself to get into the special finance business!

There are very few dealerships that don't share this experience occasionally. It is the time when the Special Finance manager knows the true meaning of the word “pressure”.

It is the same kind of pressure that is felt after the used car manager has spent $800 on reconditioning a trade-in, or sold it at the auction, only to find out that after three weeks the customer (who is driving around in a new car) had a 45-day job gap two years ago and the deal is being sent back.

Did I mention the scenario where the trade payoff was made after the lender's rep told the finance office they had funded a deal, only to find out, a supervisor would not sign off on it and the deal was sent back? Probably it was that same instance where the customer had been running 90 days late at a bank, and the banker did a tap dance in the street when he received the payoff check!

These are real world scenarios. In 6000+ special finance deals, even with the tightest of controls, I guarantee my dealership has been there. Now I can say, I have found a solution. It is called Interim Funding (www.interimfunding.com).

Quite some time ago when I first saw it, I was skeptical. It was probably like all the other lenders. Big promises, but as the phrase goes, “Show me the money! ”I did my due diligence, still was skeptical, but decided it was worth a chance. Every once in a while even a blind squirrel can find an acorn. I have even seen a smile on my finance manager's face!

Interim Funding, based in a suburb of Chicago, actually guarantees the funding of your contracts. No insurance, skips, bad telephones, job gaps, even loss of jobs—if something like this occurs, the deal still gets funded To make matters better, should you desire, you can actually interim fund (catchy idea for a name?) the deal through them by depositing a draft to have the use of the money, while it is going through the lenders funding process.

Too good to be true? Costs an arm and a leg? Not at all. Our average cost per deal has been $79, and $130 if we interim fund. How does that compare to lost retail or wholesale deals due to a back-lot full with trades that you can't do anything with because the deals haven't been funded? What does it cost to errantly make that payoff mistake? What does it do to your CSI surveys when you can't make the payoff on the trade because the deal hasn't funded, but the lien holder is pressuring the customer for his overdue payment ?

This column isn't designed to sell Interim. But as a dealer, I like to hear about how a company performs from other dealers. I am then more apt to believe it. Dealers that get into Special Finance or a short time only to get back out often do it because of the headaches of funding. For us it has helped us reduce our contracts in transit by 50% and keep it there for six months. That is significant. My special finance department enjoys the “second set of eyes” on the deal documents, and that keeps them fresher. That, too, is significant. Finally, I was so suspect of a particular lender that the only way I would allow my finance manager to do business with them was if the deals could be guaranteed. The lender just two weeks ago finally went down. All my deals got funded. That is really significant.

The “Monday Mornings” have always been part of the car business, but to some dealers, the nightmare of Special Finance contracts-in-transit has been the barrier preventing them from reaping he rewards that come from the niche. That barrier just got much smaller!

Greg Goebel is the Dealer Principal of AutoChoice Hyundai as well as the owner of AutoChoice America, a stand alone Buy-Here Pay-Here operation. He was on the Executive Committee of the National Independent Auto Dealers Association for the past four and one half years, most recently serving as Vice-President at Large

As appears in September/October 2000 World Of Special Finance Magazine. Reprinted with permission

1. What I claim is a unique and improved business method or process which, when following the steps plus functions as described in the detailed description, provides a useful, concrete and tangible result of enabling an automobile dealer or other business selling property purchased by consumers utilizing financing with a retail installment contract; the ability to have immediate monies and protection from any or several risks of not receiving monies as a result of the assignment or sale of retail installment sales contracts or other instruments of finance; such as, but not limited to, leases, portfolios of several contracts, or invoices for cash sales being rejected and returned “unpaid.” The benefits to the Interim Loan Guarantee Method Customer include, but are not limited to:
1.) Immediate cash to replace inventory
2.) Immediate cash to pay government fees such as sales tax, licensing, etc.
3.) Immediate cash to pay commissions and related sales expenses
4.) Protections from the assignment being rejected by the approving lender due to any one or several reasons or situations as described in the Description and Summary. See article “Solution for Monday Morning Madness” published Oct 2000 in World of Special Finance Magazine

2. I also claim the process or method described in claim “I” and detailed in the “Summary and Detailed Description” as being able to be processed on computer via use of the Internet on an “e commerce” or “B to B” basis.

3. It is further claimed that although the background, description and summary include references to Interim Funding LLC (the initial company to utilize the improved method or process), this is done for descriptive purposes; and the process and/or method could be utilized by license or assignment to other companies either now in existence or to be formed. Interim Funding, LLC has elected not to pursue the patent process; thereby permitting me to pursue as the inventor and sole owner of the patent.
